(19) United States
(12) Patent Application Publication
(10) Pub. No.: US 2008/0270148 A1
(43) Pub. Date: Oct. 30, 2008

(54) SALES METHOD AND DEVICE TO ASSIST IN MANAGING BUYING DECISION ISSUES

(76) Inventor: Sharon Drew Morgen, Austin, TX (US)

Correspondence Address: ZARLEY LAW FIRM P.L.C., CAPITAL SQUARE, 400 LOCUST, SUITE 200, DES MOINES, IA, 50309-2350, US

(21) Appl. No.: 11/739,740

(22) Filed: Apr. 25, 2007

(51) Int. Cl. G06Q 10/00

(52) U.S. Cl. 705/1

(57) ABSTRACT

A method and tool for assisting a sales person in identifying and managing buying decision issues where decision facilitation tools are provided either in a computer-based application, card based question set, or a PDA tree-based application device that will assist a sales person in correcting a sales problem in the field the moment it occurs, and managing the communication, decision making, rapport, and collaboration elements necessary for a buyer to make a buying decision and choose one particular vendor (i.e. the seller). Upon identifying these factors, the computer-based application, card based question set, or PDA tree-based application provides sets of decision and risk factors where the sales person is able to evaluate the risk level of the sales call to determine whether further assistance from the sales person is needed. Upon determining that a sales situation is at high risk of not closing or being time extended, the card, booklet, or PDA provides examples of Facilitative Questions that the sales person can use based on the specific buying decision issues that have not been managed.

### BACKGROUND OF THE INVENTION

This invention is directed toward a sales method and tool and more particularly to a method and tool that assists a sales person in closing sales based on managing a buyer's buying decision issues.

Conventional sales gives sellers tools and methods to sell, place and promote a product. But buyers buy based on unique buying criteria that remain hidden to the seller. There has been no way for a salesperson to truly know what is going on within a buyer's buying environment to allow the salesperson to help the buyer manage a purchasing decision. Indeed, sellers have no way of knowing what exactly is going on within the buyer's culture because they don't live there. As a result, sellers only sell to a small fraction of their prospective buyers and have no way of knowing exactly what is happening within the prospect's decision environment.

As one example, before learning of a sales recovery method, many sellers are unable to recognize the difference between what they will hear when a sale is going to be successful, or when a sale is going to be unsuccessful. Conventional sales training does not adequately teach the signs or words that provide a good indication that a sale will be closed or when the sale will fail and as a result sellers don't have the ability to make interventions at the points along the way that would prevent a failed sale.

Many sellers assume that if they understand a buyer's identified problem (because they have heard something similar so many times) they will be able to sell their product and close. This false assumption leads to sellers often misdirecting their effort to target a product placement rather than use their interactions to support buyers in making their best decisions based on their internal systems issues (people, policies, relationships, biases, beliefs, values, criteria, historic political issues, etc.). Because of this, sales persons move forward in the sales process by making too many assumptions that are not based on the same assumptions that buyers make, leaving confusion on both ends, and a slow sales cycle. This can lead to negative consequences and missed opportunities. The salesperson can disagree with the customer and thereby alienate the prospect, they can push the features of the product regardless of the customer's needs and alienate the prospect, and further alienate the prospect by going around their contact. Or the salesperson gives something away to make themselves more invaluable to the customer. Occasionally, these techniques work, but more often than not they waste time.

Further, when a sale is lost, often a seller doesn't know the reason why. Indeed, sellers never know what decisions were behind these objections and have not been able to shift the situation to a new decision and sale due to their focus on selling product rather than supporting the making of a new decision by the prospect.

Needed is a device and method that will address all of the above issues and give sellers the tools to be able to (1) understand exactly where they are at in relation to a possible closed sale with a Pre Test capability; (2) have a tool set at their disposal that gives them a specific type of decision facilitation question that teaches the buyer how to make all of their own best decisions; (3) take a Post-Test to show them their level of success in helping buyers make buying decisions and show them the additional issues that need to be managed to get a closed sale; and (4) make the entire fact pattern, communications, and decision factors available to store to remember and store for future use and management.

The device and method is populated by a decision facilitation method known as the Morgen Buying Facilitation Method®. The method introduces a process to be used by sellers to lead a buyer through the examination of all the variables that need to be included in deciding how a new solution will enter the buyer's systems. In short it teaches buyers how to make buying decisions.

As part of this Methods a unique form of question—the Facilitative Question—is used to help buyers uncover the elements necessary to make decisions based on their own unique and hidden criteria. Additionally the Method will move the buyer-seller communication along rapidly in a way that brings buyer decision-making to an efficient level that includes all relevant decision makers.

The needed device and method will help track the progress of multiple sales calls and allow this tracking to be monitored by a manager for review and evaluation. Also, the device and method provide a quick and easy reference for a salesperson to use in real time during a sales call or on the phone. No tool or method has existed in the art for a sales method and tool that addresses these deficiencies.

An object of the invention is to provide a tool and method that assists a salesperson in recognizing when a sales situation is going badly.

A further object of the invention is to provide a sales tool and method that is simple and easy to use that also provides a means to track the progress of the buying decision.

Another object of the invention is to provide a method and tool for transferring sales progress information to a manager for a company-wide evaluation of the buying decision.

These and other objects will be apparent to one of skill in the art based on the following written description.

### SUMMARY OF THE INVENTION

A method and tool for assisting a sales person in identifying issues involving behaviors and problems that show the seller the status quo of a prospecting situation, and then move forward to help the buyer manage the buying decisions themselves where information is provided either in a computer-based application, card based question set, or a PDA tree-based application device that will assist a sales person in correcting an issue that is keeping a buyer from making a purchasing decision, and teach buyers how to recognize and manage the internal elements they need to address before a decision can occur. To help identify these factors, the computer-based application, card based question set, or PDA tree-based application provides a set of risk factors where the sales person is able to evaluate the risk level of the sale.

Upon determining that a sales situation is at high risk of not closing or being time extended, the card, booklet, or PDA provides examples of Facilitative Questions that the sales person can use based on the types of buying decision issues that have not been managed according to the factors that are coded within a Pre Test. A Post-Test is conducted to show the level of success in helping a buyer manage issues and identify remaining issues that need to be managed.

### BRIEF DESCRIPTION OF THE DRAWINGS

FIG. 1 is a schematic of the environment where a sales tool would be utilized;

FIG. 2 is a flow diagram of a method of assisting a sales person;

FIG. 3 is a plan view of a tool for assisting with a sales call; and

FIG. 4 is a perspective view of a tool for assisting with a sales call.

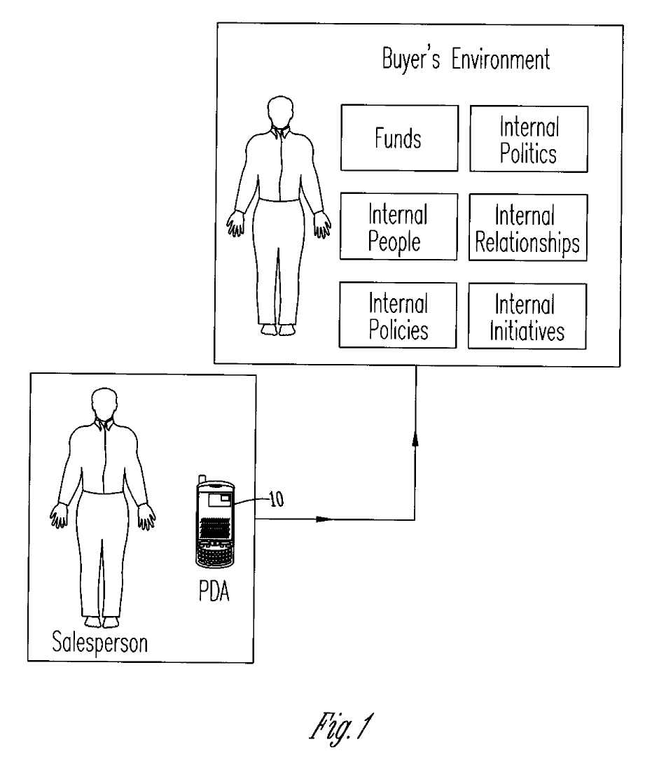

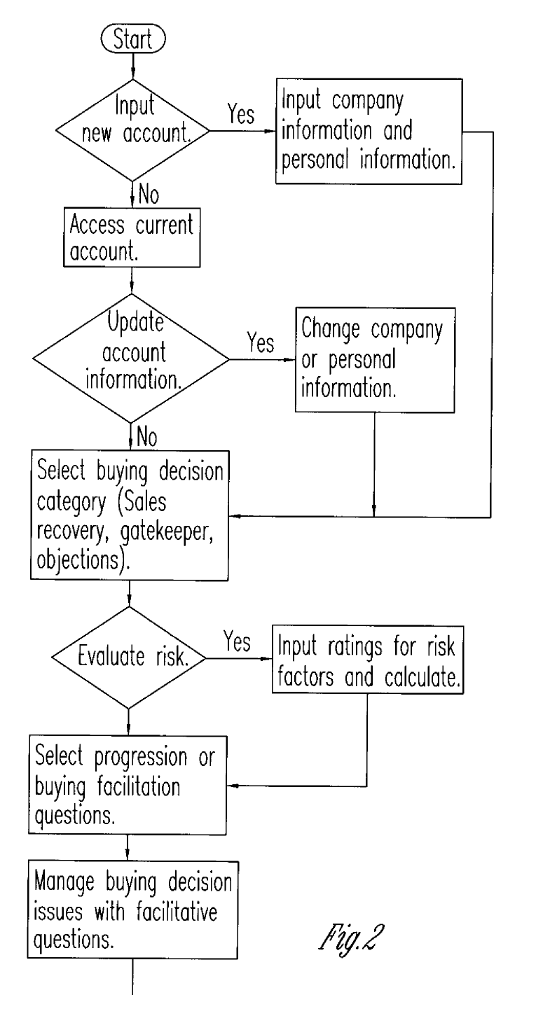

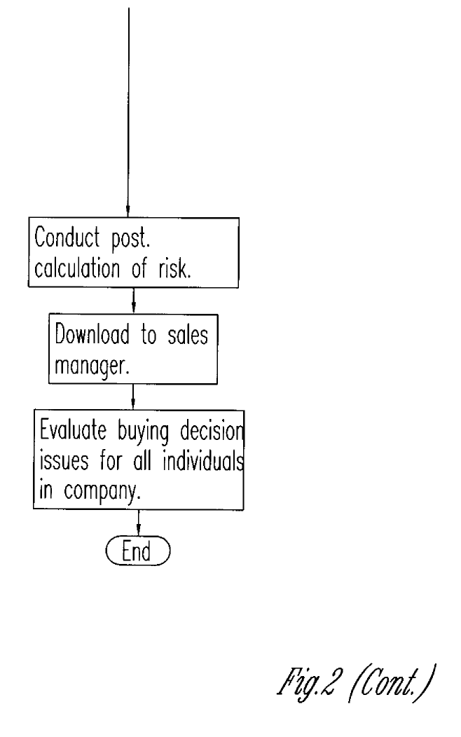

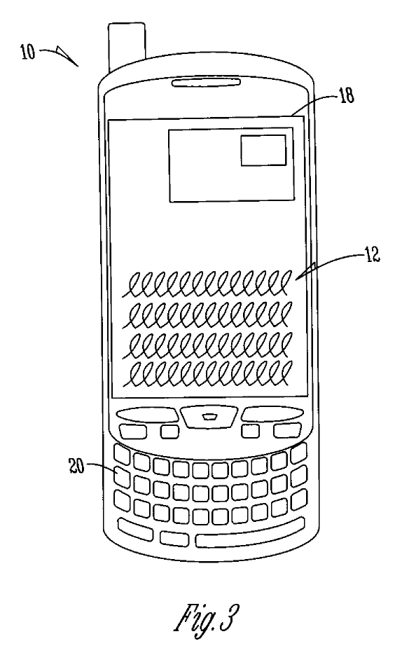

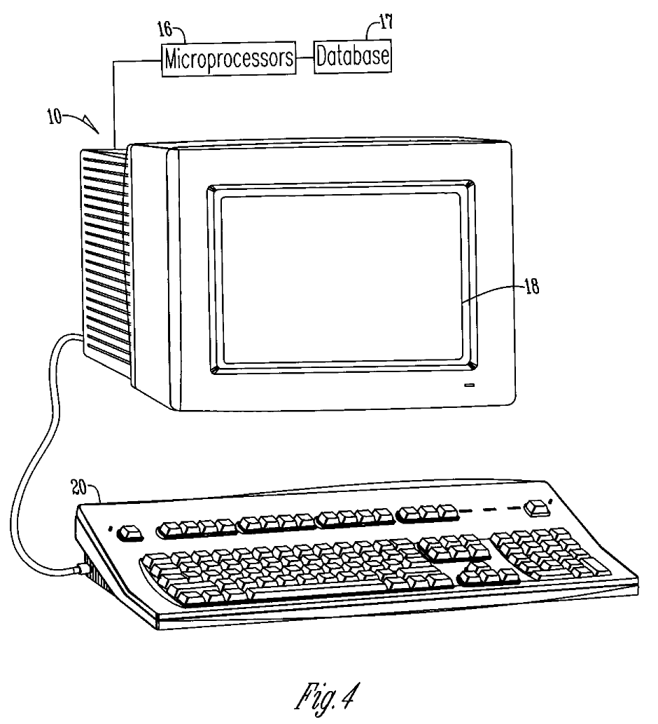

### DETAILED DESCRIPTION OF THE PREFERRED EMBODIMENT

There are a certain number of systems within a buyer's environment of people, policies, relationships, and initiatives that affect how buying decisions are made. For change to occur or something new to be added, these systems must be managed. Referring to the Figures, the method and device 10 gives salespersons tools to help buyers manage their internal environments and make it possible to manage all of the internal issues that create and maintain problems in the decision process.

The first step is to understand and manage the progression of issues buyer's have in making a purchasing decision. Generally, these signals include systemic issues that are created and maintained by a buyer to hold an identified problem in place in order to maintain the buyer's status quo. As soon as the identified problems are resolved, the buyer will be able to make a purchasing decision. By assisting a buyer in recognizing, managing and aligning various issues so that they are assured that there will be no chaos/disruption once they solve the identified problem, the salesperson will easily be the buyer's chosen salesperson.

Each buyer has an internal environment that needs to be managed prior to making a purchasing decision. Without managing the buyer's internal environment there likely will be no sale no matter how badly the buyer needs the product or how much pain the buyer is in. Salespersons generally do not understand the progression of these issues and are unable to assist and influence buyers. Through the use of facilitative questions (i.e., questions that assist a buyer to identify needs and issues in contrast to questions that attempt to gather information to push a product) a salesperson not only can understand the progression, but also influence a buyer to make a decision more quickly.

The progression of issues that might delay or stop a sale from occurring are as follows. First, if the decision team either is not aware of issues that need to be decided upon or unwilling/unable to make decisions, no purchase is likely to be made. Examples of facilitative questions that can assist a buyer in managing this issue are as follows: (1) How will you and your decision team know that you are addressing all of the elements that will affect you once a new solution is brought in?; or (2) I am familiar with many aspects of how my product fits into environments, although I do not know the specifics of your environment. What would you need to hear from me in order to help you recognize all of the system components that need to be managed to ensure a successful implementation?

Second, until the buyer confirms where funds are coming from and gets agreement for the expenditure, no purchase can be made. An example of a facilitative question that can assist a buyer in managing this issue is: At what point do we need to manage the financial end of our discussions to ensure you and your decision team will have the time to get funds freed up when you are ready to make the purchase?

Third, until buyers can choose between competitive products/vendors, they will not make a decision. Examples of facilitative questions that can assist a buyer in managing this issue are as follows: (1) There are many products that are similar to ours on the market. How would you know that one product over another would be the right product for you?; and (2) Most products on the market in your field are very similar. Since you are going to have to decide, what criteria are you and your decision team going to be using and how will you know that I can match those criteria given the amount of similarity there is between products?

Fourth, until the buyer is fully cognizant of all of the internal people, policies, politics, relationships, and initiatives and understands how to manage them up front so that no disruption will occur when the solution is brought in, no purchase will be made. An example of a facilitative question that assists a buyer in managing this issue is as follows: What has stopped you from solving this problem before now and how will you know what people, policies, politics, relationships, and initiatives need to be addressed up front to enable your full complement of decision makers to get on board at their earliest opportunity?

The method and device helps a sales person manage and effect change in each aspect of the closing/decision process so the salesperson can make an intervention when the sale is either going badly or being hopelessly delayed. There are many parts of the buying decision process where the method and device may be used such as sales recovery, handling gatekeepers, handling objections, and the like. For purposes of example only, the method and device 10 will be shown as applied to sales recovery aspect of the buying decision.

The method and device 10 are different than conventional sales methods and tools that merely teach a salesperson how to position their product, manage relationships and resistance, and support customer needs—all based on the assumption that a problem that shows up like the one the buyer seems to have will be solved by the seller's solution. The device 10 actually leads the buyer through all of their internal decisions, necessary for their entire decision team to agree to a new product purchase—agreements that must take place before any purchasing decision gets made, and must include the management of historic systems factors that have caused the Problem situation to occur to begin with.

The device 10 includes information 12 that not only lists the progression of issues, but also provides Facilitative Questions that a salesperson uses for assisting the buyer in managing these issues.

### The Sales Management Device

The device 10 is used by a sales person to serve as a reference tool to determine where they are at any point in a sales cycle, give them tools to mitigate impending failure, manage situations as they are happening in Real Time (in the field or on the phone) and assist in moving the sale forward by helping them line up all necessary decisions. The device is of any type such as a computer-based application, a card based question set, or a PDA tree-based application.

For the card based set of questions, which could be bound in a booklet form, there are separate cards or pages that outline the progression buying decision issues, cards that identify the various buying decision components, cards that provide examples of what a successful and unsuccessful sales call looks like, cards that outline risk factors, and cards that provide samples of Facilitative Questions for particular buying decision components that need to be managed and present a risk that the sale will not close.

In another embodiment the device 10 is a computer-based application for use in a laptop computer or a handheld PDA device. The laptop and PDA device are conventional having a microprocessor having a database 17, a display screen 18 and an input device 20. The input device 20 is a keyboard, mouse, or touch screen.

When activated, the processor 16 sends a signal to the display screen 18 asking if the sales person wishes to create a new account or access existing accounts. If the sales person, through the input device 20, chooses to create a new account, the processor 16 will send a signal to the display screen 18 prompting the sales person to input account information such as company name, address, phone number, decision made. etc. This information is stored in the database 17 for future reference.

### Table of Contents/Stored Data

Once an account is created or accessed the processor 16, through the display screen 18, displays a menu of options that might include a Pre-Test, a Post-Test, buying decision components, risk factors, uses of Facilitative Questions, decision team issues, objections, or other areas of the sales process.

From this disclosure a method and a tool have been disclosed that at the very least meet the stated objectives.

### Pre-Test

As an example of how the device and method works, the device 10 will display set points that will identify a sale that is proceeding and one that is failing. Users will check off the points in the pre test and then recognize whether or not the sale will be successful or unsuccessful.

The processor 16 sends a signal to the display screen 18 that displays buying decision components that are necessary in order to close a sale. The device 10 points out each of the elements that the seller has managed, and which ones have been omitted to date. The device 10 will include all issues that will show up when the sales is being successful, and those that show up as part of a failing sale. The components that sellers must ensure that they are managing include the following:

1) The unique hidden systems issues (involving politics, people, relationships, vendor management, and strategic initiatives) that would need to be addressed before any change or buying decision could take place. These issues might include, but not be limited to: timing, budget, implementation problems, relationship issues, personal biases and history, and internal, historic decision issues that might cause problems.

2) All the people and relationships that must be managed and included and how to help those on the decision team (i.e., other vendors, interdepartmental partners, business partners, immediate team) make new decisions to fix the identified problem.

3) The buyer's understanding the historic issues that got the buyer where they are now and how those issues will be mitigated/managed to ensure necessary buy-in to move forward.

4) Identifying money issues to allow the decision to move forward and, if relevant, ensuring that the buyer knows how to manage a new budget item necessitated by a new product offering.

5) Determining outcome and use issues that would be problematic through transition and implementation.

6) Determining how the salesperson's solution will meld with or replace whatever has taken its place until now and the buyer and decision team know when it is time to change.

7) Obtain full plan acceptance, adoption, and implementation, that includes people, policies, timing, and relationships, that the salesperson needs included in order for a buying decision to happen.

8) Knowing how to manage the change so there will not be a disruption.

9) Knowing the full range of decision partners who should be working with the seller to move the purchasing decision forward.

In the following table are examples within the Pre Test of what a successful sales call looks like compared to problem sales call for each of the buying components.

| Buying Component | Successful Sales Call | Problem Sales Call |
|---|---|---|
| 1. Unique hidden systems | A plan outlining the | The sales person has no |
| | actions of the identified | knowledge of, and no |
| | problem and those on the | involvement with the full |
| | decision team who will be | range of players on the |
| | closely involved in the | decision team, and no |
| | buying process are outlined | understanding of what |
| | showing how to move | needs to happen for the |
| | forward each step of the | sales person to support the |
| | way. | buying process (i.e., new |
| | Salesperson has had | decision partners will |
| | discussions and formed | appear out of nowhere). |
| | action items around the | Sales person will have no |
| | timing, budget, and | access to the action items |
| | implementation problems | or internal concerns about |
| | including internal decision | timing, budget, and |
| | issues that might cause | implementation problems |
| | problems. | or internal decision issues. |
| | | (i.e., a series of surprise |
| | | objections will appear |
| | | seemingly out of |
| | | nowhere). |
| 2. Know all the people | Sales person knows all | Sales person has only one |
| issues related to the | individuals on the decision | or two points of contact, |
| buying decision. | buying team and has had | with no idea of the full |
| | an opportunity to meet | range of necessary |
| | with them and discuss | collaborators, and will |
| | issues that identify the | have no knowledge of the |
| | problem. | large array of people |
| | | issues that will create |
| | | stress on the buying |
| | | decision and hold the |
| | | decision up. (i.e., there are |
| | | no other decision makers |
| | | present other than the |
| | | person the salesperson is |
| | | speaking with and the |
| | | buyer does not introduce |
| | | or include anyone else on |
| | | the team in the discussions |
| | | with the sales person). |
| 3. Understand the historic | Sales person knows how | The sales person only has |
| issues. | the identified problem | knowledge of the area |
| | developed and has | directly around the |
| | discussed with the buying | identified problem and not |
| | decision team how those | the full set of |
| | issues will be | circumstances and politics |
| | managed/mitigated to | that allowed the identified |
| | ensure the necessary buy in | problem to be left |
| | to move forward. | unresolved until now. |
| | | i.e., people, politics, |
| | | relationship issues will |
| | | mysteriously emerge and |
| | | partner problems appear |
| | | that were never initially |
| | | discussed). |
| 4. Money issues. | Sales person is involved in | Sales person hears |
| | discussions about money | complaining about price |
| | where the buyer figures out | and discussions of a need |
| | how to manage the | to purchase a product more |
| | finances of the project. | inexpensively. (i.e., |
| | | money objections half way |
| | | into the discussions that |
| | | were not originally noted). |
| 5. Outcome and use issues. | Buyer knows how the | Sales person will only be |
| | product will be used and | aware of how his/her |
| | how that use will change | product will manage the |
| | and manage future needs, | identified problem. (i.e., |
| | with mitigating factors | objections will emerge |
| | managed should the use | about the use of the |
| | need to shift after the | seller's product, some of |
| | purchase. | the features that appeared |
| | | fine to begin with, and |
| | | doubts about use will |
| | | emerge). |
| 6. Replacement issues | Sales person knows how | Sales person will not |
| | the solution will replace | necessarily know what |
| | present item and buyer and | systems or product has |
| | decision team know when | been used in place of the |
| | it is time to change. | sales person's product and |
| | | provided the fix for the |
| | | buyer before now. (i.e., |
| | | time delay issues, |
| | | questions about features, |
| | | questions about |
| | | competitor's products and |
| | | about why the seller's |
| | | product is better than the |
| | | competition and familiar |
| | | vendors will appear). |
| 7. Full plan for acceptance | Sales person has a plan for | Sales person will know |
| | acceptance, adoption, and | only how the area |
| | implementation, that | immediately surrounding |
| | includes people, policies, | the identified problem will |
| | timing, relationships that | be resolved by his/her |
| | need to be included for a | product. (i.e., time delays |
| | buying decision to happen. | that weren't planned |
| | | occur). |
| 8. Know how new solution | Sales person knows how | Sales person may not be |
| fits. | the new solution will meld | aware of old solution and |
| | with parts of the old | may not have |
| | solution so there will not | conversations with |
| | be a dramatic, and disruptive | prospect as to how to |
| | change. | reduce disruption when |
| | | moving from original |
| | | solution to new solution. |
| | | (i.e., new concerns about |
| | | timing, disruption, and |
| | | unknowns appear). |

The information is provided in many forms to provide easy access and quick reference for the salesperson such as a printed card, information printed in a small field hand book, or displayed on a PDA via a computer program.

The next part of the Pre Test is to determine the risk of losing a sale and evaluate where a sale is in relation to it's imminent success or failure to close. An example of risk indicators are as follows:
1. Buyer does not return phone calls within 48 hours.
2. Buyer provides vague answers when sales person calls to check in.
3. New financial/budget problems have surfaced.
4. New business problems delay the decision.
5. New/old partners show up and are involved in the solution.
6. Everything is moving along fine and there is nothing to discuss.
7. Buyer advises that they are going to stay with the current situation for now.
8. Buyer indicates that they need to have a cheaper solution.
9. The old vendor is now involved.

To evaluate the risk of losing a sale or facing an overly long sales cycle a salesperson rates each of the above nine factors on a scale of 1 to 5 where 5 indicates a high probability of closing and 1 a high probability that the sale will not close. The sales person inputs these ratings through the input device 20 and the processor 16 determines and then displays through the display screen 18 the probability that the sale will not close. By rating the risk of not closing the sales person is better able to evaluate which prospects need attention and management of buying decision issues.

Once the Pre Test shows that a prospect is determined to be at a high risk of not closing the sales person uses the input device 20 to find the right Facilitative Questions to read and say that will manage the buying decision issues. More specifically, the processor 16 through the display screen 18 displays the buying components for a particular prospect that need attention and management. The sales person, through the input device 20, selects one of the buying components and the processor 16 provides at least one related Facilitative Question for display. The device 10 will also produce a signal such as verbal clues that will indicate to a sales person when they are in trouble. The following are examples of Facilitative Questions that can be used by a sales person to help manage these buying issues.

### EXAMPLE 1

The buyer states that one of their partners just contacted them and might be able to help straighten out the problem. Sales person responds, “I hear that you might be able to resolve your problem internally. Good for you. What has stopped you from seeking their support until now?”

### EXAMPLE 2

Buyer states that they have a new initiative starting soon and that they will need to wait until they are farther along on the implementation before they can move forward. Sales person responds, “Sounds like you've got a lot on your plate. How would you know that it would make sense to begin considering a solution design so that when you were at the right point in your current initiative, you would be able to begin preparing for the new solution so that when the need is present the solution would be available?”

### EXAMPLE 3

Buyer states that they are going to continue using what they have for now and asks that the sales person call in several months to see if they are in a better position them. Sales person responds, “So it sounds like there are many issues that you must manage internally before it would be prudent to try to upset the status quo with a new solution. How would you and your decision team know when it was time to bring in a new solution and how would they know that the solution we have would be the one that would solve the problem?”

The tool 10 is used for each conversation the seller has with the buyer, and a pre-test is used prior to each interaction. This will give the seller and the seller's manager the ability to follow the sale—through each interaction and each buyer/decision maker within the prospect's decision team.

Each interaction will bring the sale closer to the number of components that need to be managed before the sale will close. For example, on a Pre Test, if the seller shows they have managed most of the components of a successful purchasing decision they will appear to be closer to closing than if they have only managed a few. Because the device retains historic data of the Pre Test in the database 17, the seller and seller's manager can watch as the sale progresses and take new action as necessary.

The next time the sales person calls on a buyer they access the stored buyer or project account and display the buying components. From this display the sales person can identify and select buying components that have yet to be managed. By selecting an unmanaged buying component the seller accesses one or more buying facilitation questions specifically provided to assist the sales person in managing the buying component. In this manner, both the sales person and the manager are able to track the progress of a sales project over a period of time.

### Post-Test Evaluation

Once the sales person has determined the buying decision issues that have been addressed—either positively or negatively—and all the interactions that happened each step of the way, including the trees of Facilitative Questions that they must use to help buyers get ready to make a purchase, the sales person conducts a post-risk evaluation in the same manner as described above. In this manner, a sales person who has an understanding of the progression of buying decision issues is able to identify the moment when a problem arises with a sale.

Upon completion of each sales contact the sales person selects the risk factors for the specific account/contact and inputs new ratings. This post-risk analysis is used by the sales person to evaluate the effectiveness of the sales contact as well as track the progress of the buying decision both for the individual and the company.

The information inputted by the sales person is downloaded to a sales manager for review. From this information the sales manager provides feedback to the sales person, evaluates whether individuals with a company are at the same or similar place in the buying decision process, and makes recommendation to the sales person.

The sales person will be able to evaluate the risk of whether or not a sale will close based on the ratings given to the various risk factors. For those sales that are at a high risk of not closing the sales person can intervene and manage buying decision issues through the use of other sets of Facilitative Question trees that the device 10 offers on the PDA, Cards, computer or web based application.

After each interaction the seller inputs information on the Post Test to indicate that a particular buying component has been managed. This information is transferred, through an electronic network to a manager who reviews and provides comments or suggestions to the salesperson.

What is claimed:

1. A method for managing and influencing buying decision issues, comprising the steps of:
providing a list of decision and risk factors related to buying decision issues on a first printed card;
inputting a rating for each risk factor based upon likelihood that a sale will close,
calculating whether the sale falls within a high risk category of not closing; and
managing the buying decision issue using facilitative questions that address specific buying decision issues that are printed on a second set of cards.

2. The method of claim 1 further comprising the step of inputting a post-rating for each decision and risk factor based upon the likelihood that a sale will close and performing a post-calculation to determine whether the sale falls within a high risk category of not closing.

3. A method for managing buying decision issues, comprising the steps of:
providing a list of risk factors related to buying decision issues displayed on a screen of a PDA;
inputting a rating for each decision and risk factor into the PDA based upon a likelihood that a sale will close,
calculating whether the sale falls within a high risk category of not closing and displaying the calculation on the PDA; and
managing the buying decision issue using facilitative questions that address specific buying decision issues that are displayed on the screen of the PDA.

4. The method of claim 3 further comprising the step of inputting a post-rating for each decision and risk factor into the PDA based upon the likelihood that a sale will close and performing a post-calculation to determine whether the sale falls within a high risk category of not closing that is displayed on the screen of the PDA.

5. The method of claim 4 further comprising the step of downloading the post-calculation to a sales manager's computer.

6. A method for managing buying decision issues, comprising the steps of:
providing a list of risk factors related to buying decision and decision factor issues displayed on a screen of a computer;
inputting a rating for each decision and risk factor into the computer based upon a likelihood that a sale will close,
calculating whether the sale falls within a high risk category of not closing and displaying the calculation on the computer; and
managing the buying decision issue using facilitative questions that address specific buying decision issues that are displayed on the screen of the computer.

7. The method of claim 6 further comprising the step of inputting a post-rating for each risk factor into the computer based upon the likelihood that a sale will close and performing a post-calculation to determine whether the sale falls within a high risk category of not closing that is displayed on the screen of the computer.

8. The method of claim 7 further comprising the step of downloading the post-calculation to a sales manager's computer.

9. A method of managing buying decision issues, comprising:
providing a sales device;
accessing a list from the tool of buying components;
indicating and storing for each prospect the buying components that have been managed successfully;
accessing from the device at least one facilitative question for an unmanaged component.

10. The method of claim 9 further comprising the step of repeating the method until all buying components have been managed.

11. The method of claim 9 further comprising the step of transferring information indicating managed buying components to a manager.
